(19) United States
(12) Patent Application Publication
(10) Pub. No.: US 2012/0257618 A1
(43) Pub. Date: Oct. 11, 2012

(54) Method for Expanding a Single Chassis Network or Computing Platform Using Soft Interconnects

(75) Inventors: Yuancheng Christopher Pan, Portland, OR (US); Tian Yu, Cupertino, CA (US); Chongyang Wang, College Station, TX (US); Chunxing Huang, Shenzhen (CN); Zhenhua Xu, Shenzhen (CN)

(73) Assignee: FUTUREWEI TECHNOLOGIES, INC., Plano, TX (US)

(21) Appl. No.: 13/440,805

(22) Filed: Apr. 5, 2012

Related U.S. Application Data
(60) Provisional application No. 61/472,550, filed on Apr. 6, 2011.

(51) Int. Cl. H04L 12/50; H04L 12/66

(52) U.S. Cl. 370/355; 370/386

(57) ABSTRACT

A system and method for expanding a chassis network using soft interconnects, including a hybrid chassis comprising a first fabric card comprising a first switching fabric, a second fabric card comprising a second switching fabric, a first set of line cards coupled to the first switching fabric via a first set of hard connections, and coupled to an interface associated with the second switching fabric via a soft connection, and a second set of line cards coupled to the second fabric card.

This patent application claims priority to U.S. Provisional Patent Application No. 61/472,550 filed on Apr. 6, 2011 and entitled Method for Expanding a Single Chassis Network or Computing Platform Using Soft Interconnects, which is incorporated herein by reference as if reproduced in its entirety.

### TECHNICAL FIELD

The present invention relates to communications systems and methods and, in particular embodiments, to a method for expanding a single chassis network or computing platform using soft interconnects.

### BACKGROUND

To achieve high data rates, modern networks communicate data packets using multi-gigahertz (multi-GHz) frequency signals. The use of such high frequency signals may stress the interconnections between core network components (e.g., line cards, switching fabrics, etc.) in places of network convergence (e.g., switching centers), where packets may be switched between hundreds of thousands of interconnected ports. Specifically, hard connections may be conductive pathways of a printed circuit board (PCB) (or other variants thereof), and may experience high levels of insertion loss when transporting high-frequency signals. Consequently, hard connections may be incapable of spanning long distances without significantly compromising the signal integrity of high-frequency signals. As a result, high-frequency switching centers that rely exclusively on hard connections may be limited to relatively short interconnections between ports, which may significantly limit the switching centers capacity (i.e., the number of interconnected ports or access points supported by the switching center). Put differently, the distance between the two most remotely positioned ports increases as ports/access points are added to then switching center, hence the number of access points a switching center is capable of supporting may be limited by the inability of hard connections to transport high frequency signals over long distances.

Modern switching centers are built on modular chassis, which house multiple line cards (LCs) that are interconnected with one another through one or more fabric card (FCs). LCs may house computing engines positioned in-between a series of network-side ports (e.g., corresponding to access points of the network) and switching-side ports (e.g., ports over which packets are forwarded to the FCs). FCs may house one or more switching engines connected to a series of input/output (I/O) ports via a network of hard connections. The LCs and FCs may typically engage a connection-plane (e.g., back-plane, mid-plane, etc.), which may provide structural integrity to chassis components (e.g., LCs and FCs) as well as a plurality of interfaces from which to interconnect the switching-side ports of the LCs to I/O ports of the FCs. Generally speaking, each LCs must be interconnected with each FC to effectively switch data between all the network access points.

The number of LCs supported by the chassis may be proportional to the number of network interfaces provided by the switching center, and hence increasing the chassis' capacity may require adding additional LCs. However, adding LCs may require more and/or longer interconnections within the FC, thereby causing the length of the longest interconnection to increase. Because FCs are typically manufactured on PCBs, their interconnections generally include hard connections, and hence the length of the FC's longest interconnection may limit the capacity of the chassis. For this reason, chassis in high-frequency network may generally be limited to eight or fewer LCs. To meet ever-increasing demand for telecommunications services, techniques and architectures for expanding the capacity of such chassis is desired.

### SUMMARY OF THE INVENTION

Technical advantages are generally achieved, by preferred embodiments of the present invention which describe methods and techniques for expanding a single chassis network using soft interconnections.

In accordance with an embodiment, a line card comprising a first set of ports communicatively coupled to a first switching fabric via a hard connection, wherein the first switching fabric is capable of forwarding data to any one of a plurality of proximately located line cards without forwarding the data through any intermediate switching fabrics, and a second set of ports communicatively coupled to a second switching fabric via a soft connection, wherein the second switching fabric is capable of forwarding data to any one of a plurality of remotely located line cards without forwarding the data through any intermediate switching fabrics.

In accordance with another embodiment, a method for operating a first line card, the method comprising receiving a plurality of packets over an ingress interface of the first line card, sorting the plurality of packets to distinguish a first set of the plurality of packets from a second set of the plurality of packets, the first set of packets being destined for a proximately located line card and the second set of packets being destined for a remotely located line card, forwarding the first set of packets to a first switching fabric via a first hard connection, the first switching fabric and the first hard connection being components of a proximately located fabric card, and forwarding the second set of packets to an interface associated with a second switching fabric via a soft connection, the second switching fabric a component of a remotely located fabric card.

In accordance with yet another embodiment, a hybrid chassis comprising a first fabric card comprising a first switching fabric, a second fabric card comprising a second switching fabric, a first set of line cards coupled to the first switching fabric via a first set of hard connections, and coupled to an interface associated with the second switching fabric via a soft connection, and a second set of line cards coupled to the second fabric card

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a circuit diagram of a conventional chassis architecture;

FIG. 2 illustrates a circuit diagram of an expanded chassis architecture using hard connections;

FIG. 3 illustrates a circuit diagram of an expanded chassis architecture using soft connections;

FIG. 4 illustrates a circuit diagram of an embodiment of an expanded chassis architecture using hybrid interconnections;

FIG. 5 illustrates a circuit diagram of another embodiment of an expanded chassis architecture using hybrid interconnections;

FIG. 6 illustrates a circuit diagram of another embodiment of an expanded chassis architecture using hybrid interconnections;

FIG. 7 illustrates a diagram of an embodiment of a hybrid interconnection;

FIG. 8 illustrates a block diagram of a method for forwarding packets over an expanded chassis architecture using hybrid interconnections;

FIG. 9 illustrates a diagram of another embodiment of an expanded chassis architecture using hybrid interconnections;

FIG. 10 illustrates a diagram of another embodiment of an expanded chassis architecture using hybrid interconnections;

FIG. 11 illustrates a diagram of another embodiment of an expanded chassis architecture using hybrid interconnections;

FIG. 12 illustrates a block diagram of an embodiment of a computing engine; and

FIG. 13 illustrates a diagram of an embodiment of an x-cable harness.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

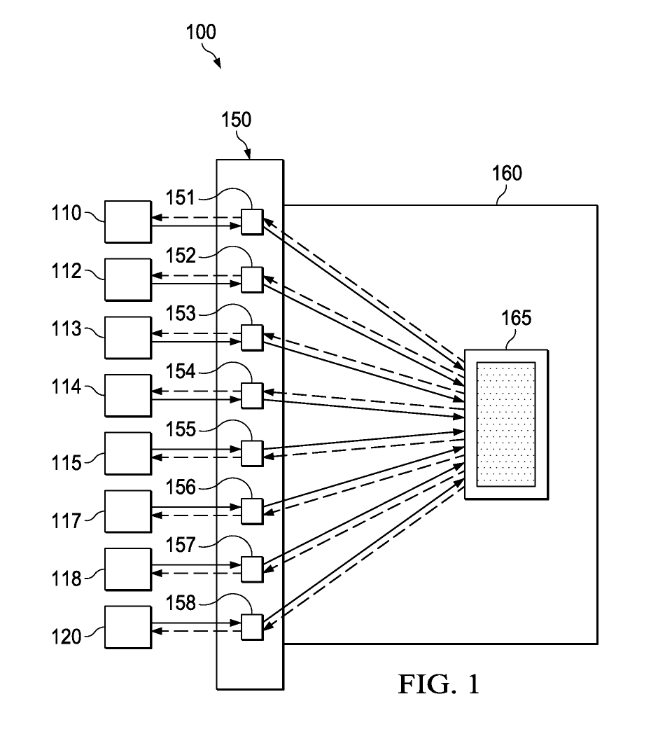

FIG. 1 illustrates a circuit diagram of a conventional chassis architecture 100 for interconnecting eight LCs 110-120 using an FC 160 and a mid-plane 150. The LCs 110-120 may house computing engines, and may provide interfaces from which users may access the network. Specifically, each of the LCs 110-120 may provide a fixed number of interfaces (e.g., 1000 ports), such that the number of LCs 110-120 is proportional to the number of network interfaces. The mid-plane 150 may be mounted to the chassis, and may provide a plurality of interfaces 151-158 for interconnecting the LCs 110-120 with the FC 160. The FC 160 may generally house a switching engine 165 (commonly referred to as a switching fabric), which may provide a mechanism for switching packets between the various LCs 110-120 in a deterministic fashion.

As shown in FIG. 1, the solid arrows correspond to hard connections extending from the LCs 110-120 to the FC 165, while the dashed arrows correspond to hard connections extending from the FC 165 to the LCs 110-120. While FIG. 1 illustrates only a single FC 160, the LCs 102-114 may be serviced by multiple parallel FCs (i.e., FCs positioned in parallel to the FC 160) to increase user throughput capacity. However, parallel FCs may not effectively increase the number of access points supported by the chassis, which may be proportional to the number of LCs. Hence, adding additional LCs (or higher capacity LCs) may be necessary to increase access point capacity of the chassis architecture 100.

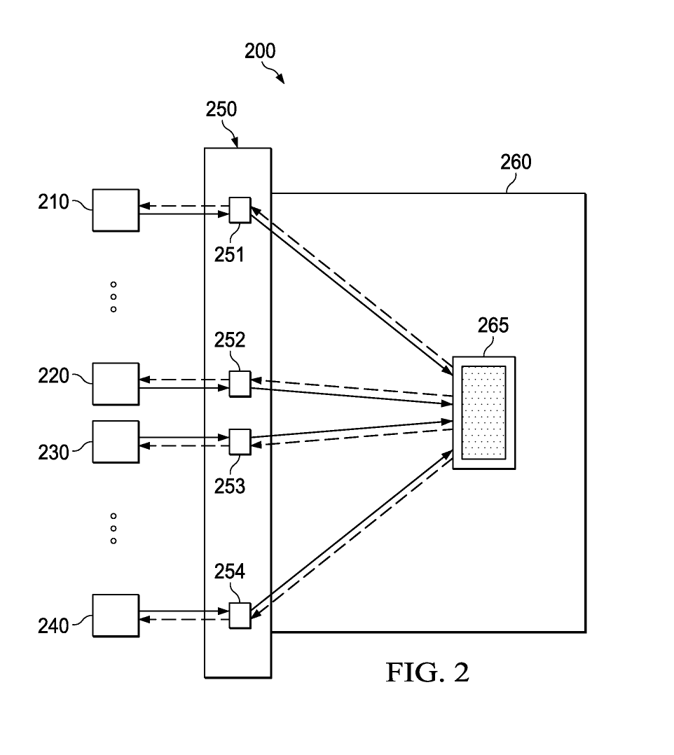

One solution for expanding the capacity of a chassis is to use larger, higher capacity, FCs. FIG. 2 illustrates a circuit diagram of an expanded chassis architecture 200 for interconnecting a plurality (e.g., sixteen) LCs 210-240 using a single FC 260 and a mid-plane 250. The FC 260 may comprise a switching fabric 265, which may used to deterministically switch packets between the LCs 210-240. Specifically, the traffic is routed from the LCs 210-240 to the switching fabric 265 using a first set of hard connections (solid arrows), and from the switching fabric 265 to the LCs 210-240 using a second set of hard connections (dashed arrows). These hard connections may be PCB connections or some variant thereof. As discussed above, hard connections are ineffective for carrying high-frequency signals over long distances, and hence the length of the longest hard connection (e.g., the hard connection from the LC 210 to the LC 240) may limit the capacity of the chassis architecture 200. For instance, the length of the hard connection between the LC 210 and the LC 240 increases as more LCs 220-230 are added (e.g., as more LCs are positioned between the LC 210 and the LC 240, the distance there-between increases). Increasing the length of this hard connection results in greater attenuation of the high frequency signal transported between the LC 210 and the LC 240. After a threshold number of LCs are added to the chassis architecture 200, the length of the hard connection between the LC 210 and the LC 240 exceeds a threshold/maximum length, at which point high frequency signals are attenuated so much that reception becomes difficult or unreliable (e.g., higher bit-error-rates (BERs)). As such, the capacity of the chassis architecture 200 may be limited by the length of the longest hard connection.

Another solution for expanding the capacity of a chassis is to interconnect several smaller FCs to the LCs using soft connections (e.g., high-speed cable). Specifically, soft-connections may be capable of transporting high-frequency signals at a much higher efficiency than hard connections, thereby allowing soft connections to substantially outperform hard connections when transporting high frequency signals (particularly over long distances). Soft connections derive this advantage by using low-loss conductive materials to form their respective interconnections, which may not satisfy one or more material constraints as required by hard connections. For instance, the manufacturing of PCBs may require that the conductive material selected for the interconnections (e.g., hard connections) satisfies certain rigidity criteria (e.g., does not float excessively at a given temperature), thereby limiting the types of low-loss materials (e.g., Teflon or polyolefin dielectric material, low-loss cladding, silver plated copper wire), thereby allowing soft connections to be designed such that their bandwidth and impedance characteristics are superior than PCB based hard interconnections at multi-GHz frequencies. low-loss material that may be used for hard connections. In comparison, high speed cable and other soft connections may be manufactured using a wider-array of low-loss materials (e.g., Teflon dielectric (PTFE), silver, copper, low-loss cladding), thereby allowing soft connections to be designed such that their bandwidth and impedance characteristics are narrowly tailored to the desired signal frequency (e.g., 1 GHz, 2 GHz, etc.).

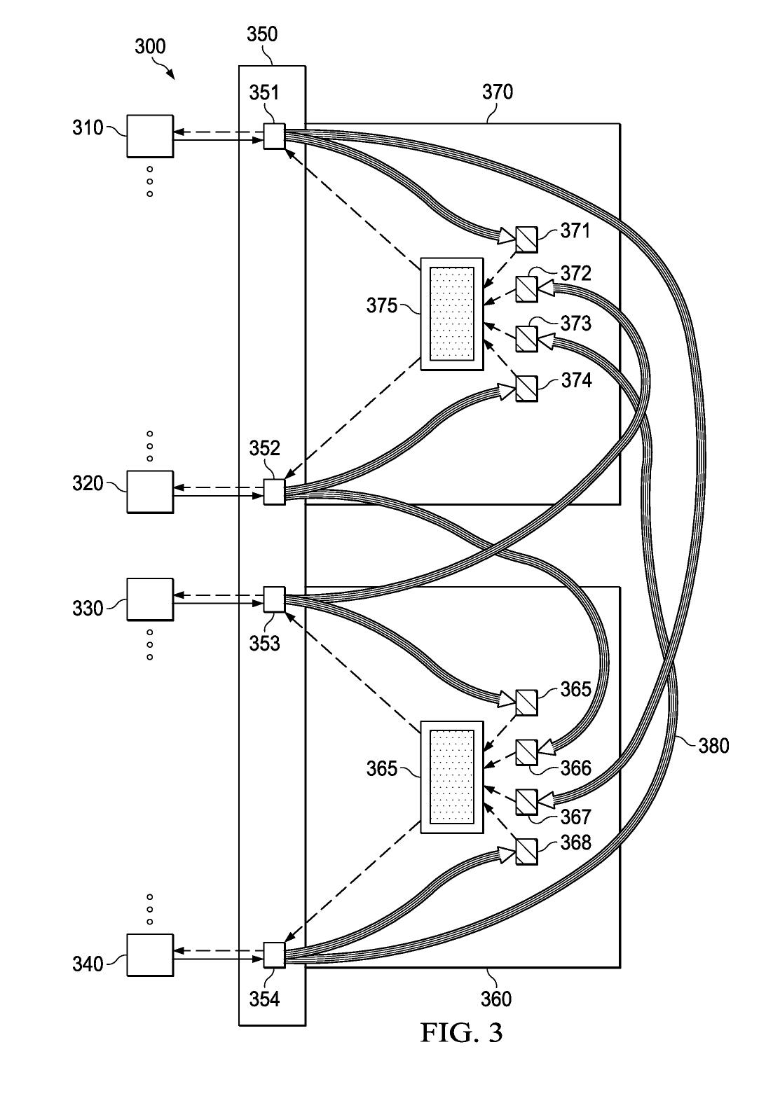

FIG. 3 illustrates an expanded chassis architecture 300 that interconnects a plurality of LCs 310-340 to a pair of FCs 360, 370 using soft connections. As shown, each of the LCs 310-340 send their signals to the FCs 360 and 370 using soft connections (striped arrows), and receive packets from the FC 360, 370 via hard connections (dashed arrows). As discussed above, soft connections (e.g., high speed cable) are more effective at transporting high frequency signals because they can be constructed out of a wider array of low-loss materials. However, soft connections are generally bulkier (e.g., consume more space) and more expensive than hard connections. As a result, the chassis architecture 300 may be larger and more costly than the chassis architecture 200. As such, cheaper and/or more-compact chassis architectures for supporting high-frequency signals are desired.

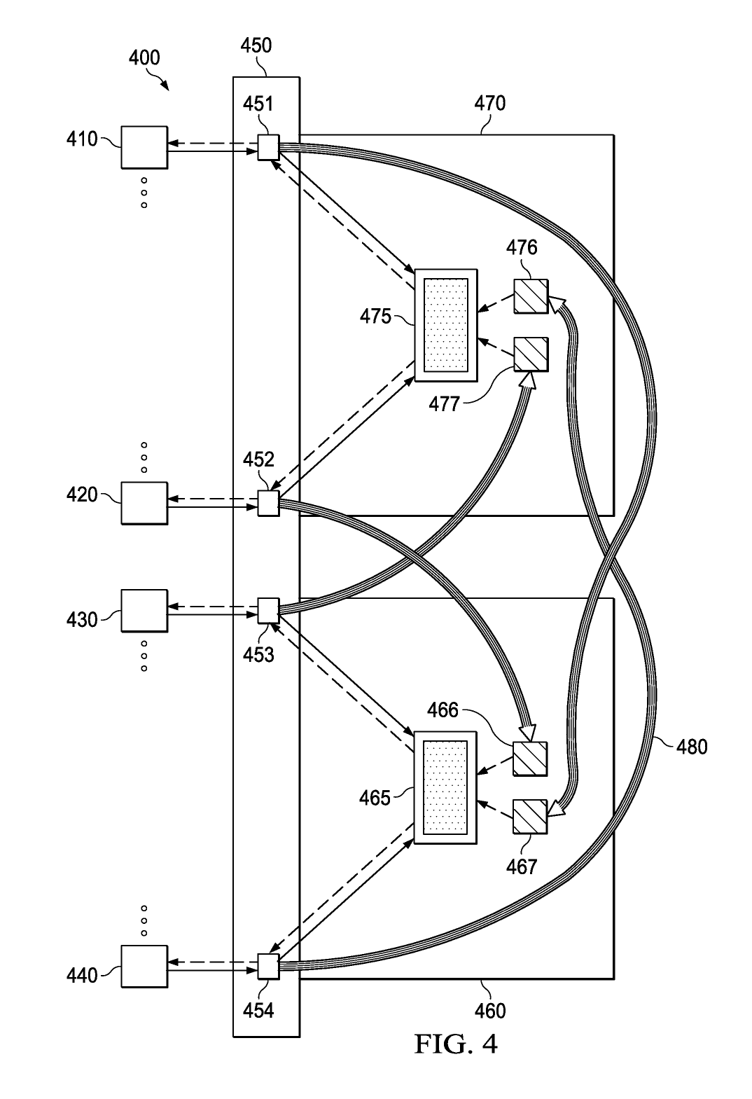

Although hard connections don't perform as well as soft connections in high-frequency applications, they may nevertheless be adequate for spanning short distances (e.g., for forming interconnections between proximately located chassis components). FIG. 4 illustrates a diagram of an embodiment of a hybrid chassis architecture 400 for interconnecting a plurality of LCs 410-440 using a pair of FCs 460 and 470 and a mid-plane 450. The LCs 410, 420 are proximately located to one another as well as proximately located to the FC 470. Likewise, the LCs 430, 440 are proximately located to one another as well as proximately located to the FC 460. Notably, the overall distance between the LC 410 and the LC 420 may be short enough to be spanned by a hard connection, without significantly attenuating high-frequency signals. As such, the LCs 410 and 420 may be interconnected via hard connections of the FC 470 without impeding their ability to exchange high-frequency packet-data. The same principle applies to the interconnections between the LC 430 and the LC 440.

On the other hand, the LCs 410, 420 are located a considerable distance from the LCs 430, 440, and consequently hard connections may not be suitable for interconnecting the LCS 410, 420 with either of the LCs 430, 440. Instead, soft connections are used to span the distance between the LCs 410, 420 and the switching fabric 465, as well as the distance between the LCs 430, 440 and the FC 475. Consequently, high frequency signals are transported over soft connections when forwarded from the LCs 410, 420 to the switching fabric 465, or when forwarded from the LCs 430, 440 to the switching fabric 475. In some embodiments, the soft connections may couple to interfaces 466-467 and 476-477 of the FCs 460, 470, rather than directly to the switching engines 465, 475. The interfaces 466-467 and 476-477 may be coupled to the switching engines 465 and 475 via short hard connections (represented by the dashed arrows), which may transport the high frequency signals without substantial attenuation (e.g., due to their relatively short length).

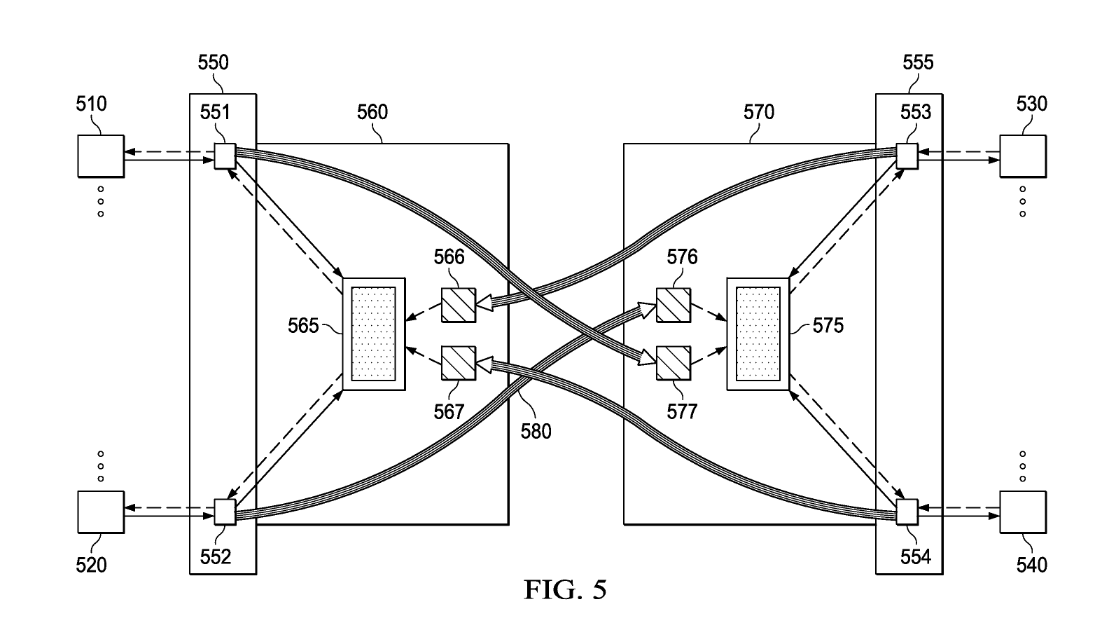

FIG. 5 illustrates another embodiment of a hybrid chassis architecture 500 for interconnecting a plurality of LCs 510-540 using a pair of FCs 560, 570 and a pair of mid-planes 550, 555. The chassis architecture 500 may be similar to the chassis architecture 400, except that the chassis architecture 500 may use dual mid-planes 550, 555, rather than a single mid-plane 450 as shown in FIG. 4. This may allow for greater flexibility in designing and/or orientating the chassis.

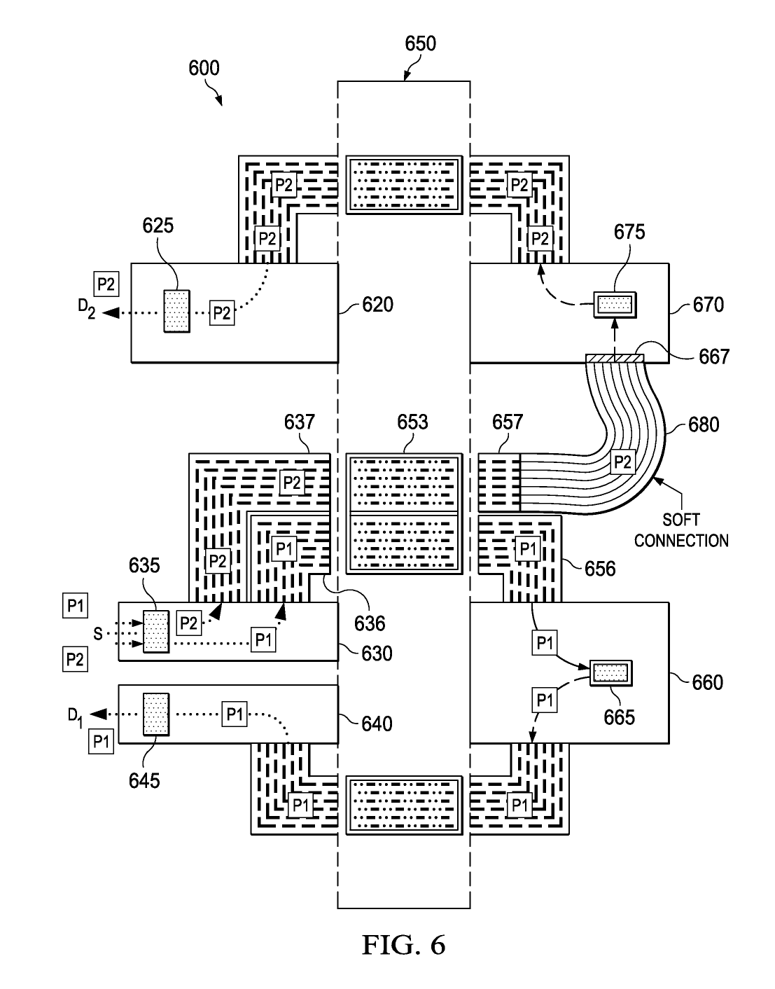

Techniques for forwarding packets are better understood when referencing FIG. 6, which illustrates a hybrid chassis architecture 600 for forwarding packets (P₁) destined for proximately located LCs and packets (P₂) destined for remotely located LCs. Specifically, the chassis architecture 600 may comprise a plurality of LCs 620-640 and a plurality of FCs 660-670 interconnected by a mid-plane 650. As shown, the LC 630 may receive the packets P₁ and P₂ from a source (S), and sort the packets using a computing engine 635. The computing engine 635 may determine that the packets P₁ are destined for a proximately located LC 640, and that the packets P₂ are destined for a remotely located LC 620. As a result, the LC 630 may forward the packets P₁ over ports 636, and the packets P₂ over ports 637. The interface 653 may couple the ports 637 to the pins 657 (which terminate at the soft connection 680), as well as the ports 636 to the pins 656 (which terminate at the FC 660). The interface 653, and the ports/pins 636-637 and 656-657 may be part of the mid-plane 650.

As such, the packets P₁ may be forwarded to the switching engine 665 via hard connections, and the packets P2 may be forwarded to the interface 647 via the soft-connection 680. The interface 647 may be located on the FC 670, and may couple directly to the switching engine 675. Hence, the packets P2 may be received by the switching engine 675 shortly after being received at the interface 667. Upon reception, the switching fabrics 665 and 675 may forward the packets P₁ and P₂ (respectively) to the LCs 620 and 640 via the pathways depicted in FIG. 6.

As shown in FIG. 6, the packets P₁ destined for proximately located LC 640 may be transported to the switching fabric 665 using hard connections, while the packets P₂ destined for remotely located LC 620 may be transported to the switching fabric 675 using the soft-connection 680 (as well as a relatively short hard connection extending from the interface 667 to the switching engine 675). Hence, packets traversing relatively short distances (e.g., the packets P₁) are transported over hard connections, while packets traversing relatively long distances are transported over soft connections. This may achieve a more efficient utilization of the expensive/bulky soft connections, by using them only when they are necessary and/or helpful in transporting high-frequency signals over relatively long distances (e.g., distances that exceed the maximum carrying length of hard connections).

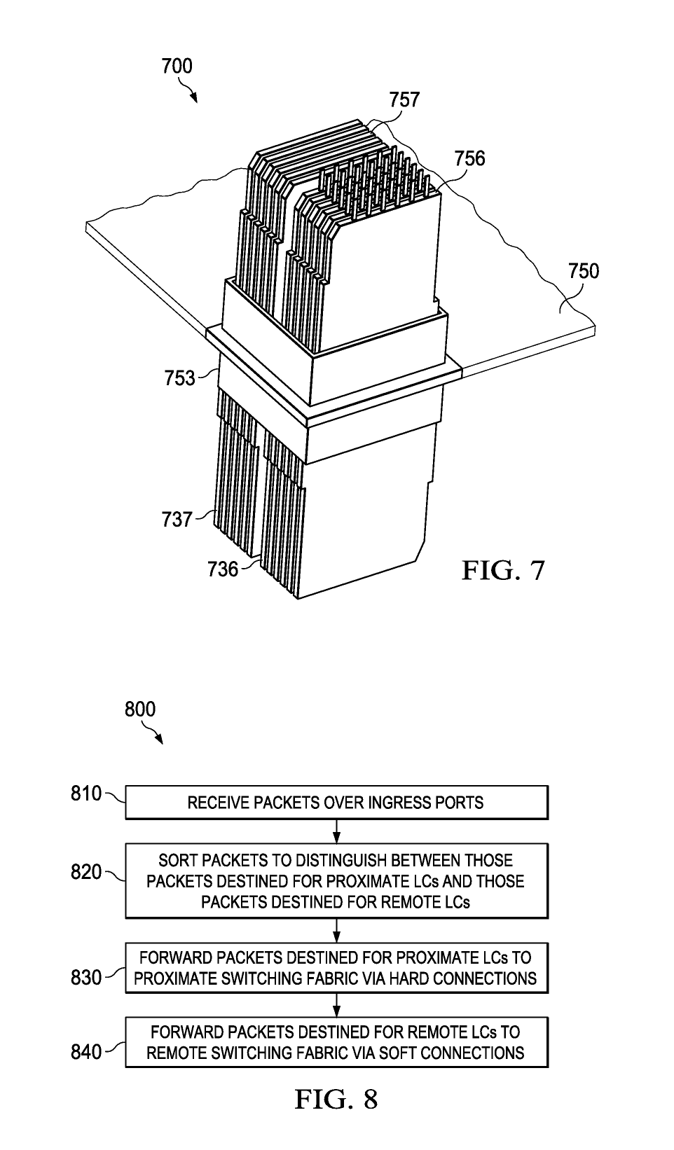

FIG. 7 illustrates a diagram of a hybrid interconnection 700, which is part of a mid-plane 750. The hybrid interconnection comprises an interface 753, from which pins 736-737 and 756-757 protrude. Specifically, the pins 736-737 may engage a source LC, the pins 756 may engage a proximate FC, and the pins 757 may engage a soft connection (e.g., a high-speed cable) that is coupled to a remotely located FC. The pins 736 may be connected to the pins 756, and the pins 737 may be connected to the pins 757. Hence, the source LC may forward packets destined for the proximately located FC (or a proximate LC served thereby) over the pins 736, and forward packets destined for the remotely located FC (or a remote LC served thereby) over the pins 737.

FIG. 8 illustrates a method 800 for transporting/forwarding packets over a hybrid chassis interconnection, as may be performed by a source LC. The method 800 may begin at step 810, where the LC may receive a plurality of packets over one or more ingress ports (e.g., network ports serving as access points to one or more users). Next, the method may proceed to step 820, where the LC may sort the packets to distinguish those packets destined for proximate LCs (e.g., the packets P₁ discussed above) from those packets destined for remote LCs (e.g., the packets P₂ discussed above). The method 800 may then proceed to step 830, where the source LC may forward those packets destined for proximate LCs over a first plurality of ports that are coupled to a proximate switching fabric via hard connections. The method may then proceed to step 840, where the source LC may forward those packets destined for remote LCs over a second plurality of ports that are coupled to an interface via soft connections. The interface may be part of or coupled to a remote switching fabric or FC which serves the remote LC(s) for which the packets P₂ are destined.

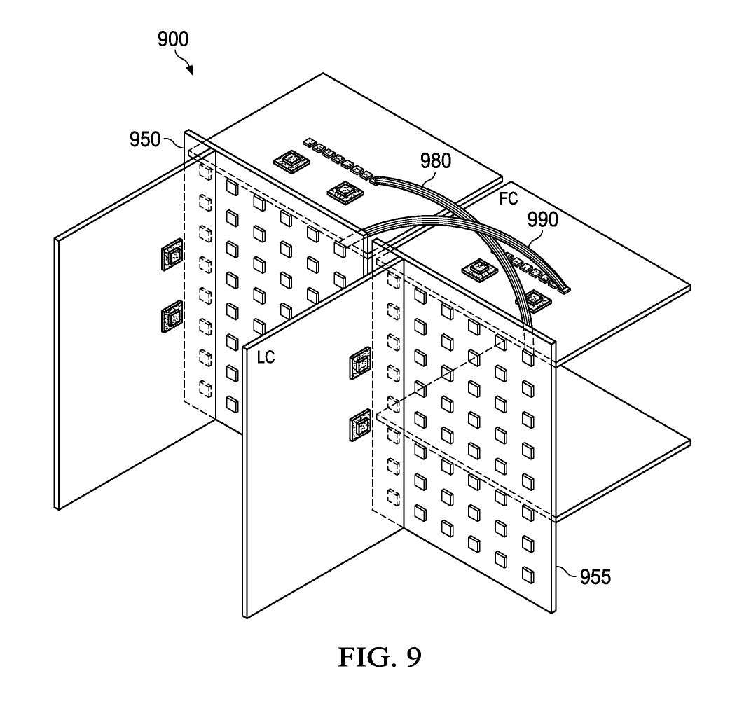

FIG. 9 illustrates an embodiment of a chassis configuration 900 comprising vertically configured LCs and horizontally configured FCs which engage a pair of mid-planes 950 and 955. As shown, high speed cables (e.g., the high speed cable 980) connect the egress interface of the mid-plane 950 with the ingress interfaces of remote FCs, as well as the egress interfaces of the mid-plane 955 with the ingress interfaces of the remote FCs.

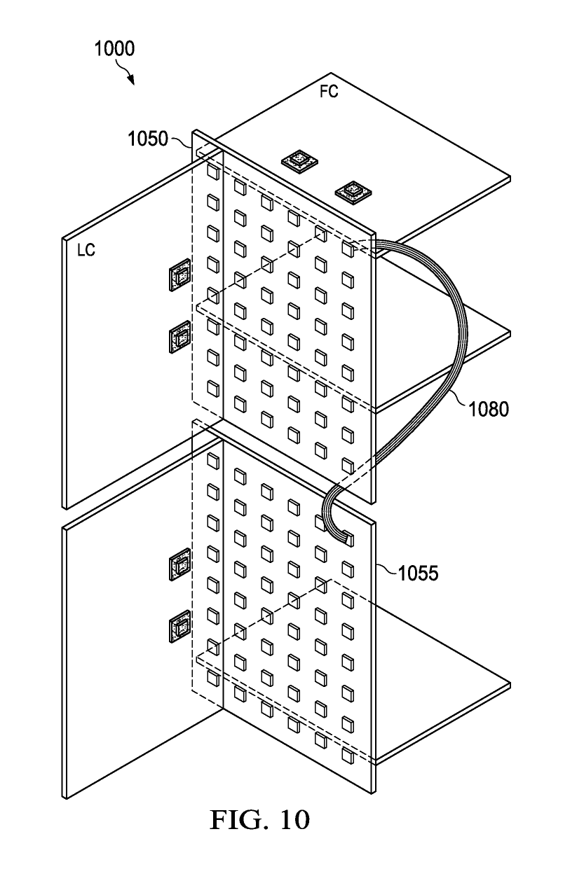

FIG. 10 illustrates another embodiment of a chassis configuration 1000 comprising vertically configured LCs and horizontally configured FCs which engage a pair of mid-planes 1050 and 1055. The chassis configuration 1000 differs from the chassis configuration of FIG. 9 in several respects. First, the pair of mid-planes 1050 and 1055 are positioned in a vertical configuration (e.g., one above the other), while the mid-planes 950 and 955 are positioned in a horizontal configuration (e.g., one beside the other). Second, the high speed cables (e.g., the high speed cable 1080) connect back-side egress ports of the mid-plane 1050 to front-side ingress ports of the mid-plane 1055. This allows packets sent from the upper LCs to be received by the lower FCs via the mid-plane 1055, rather than by a separate interface of the FC. Although not shown, there may also be high speed cables connecting back-side egress ports of the mid-plane 1055 to front-side ingress ports of the mid-plane 1050, such that packets can be transported from the lower LCs to the upper FCs.

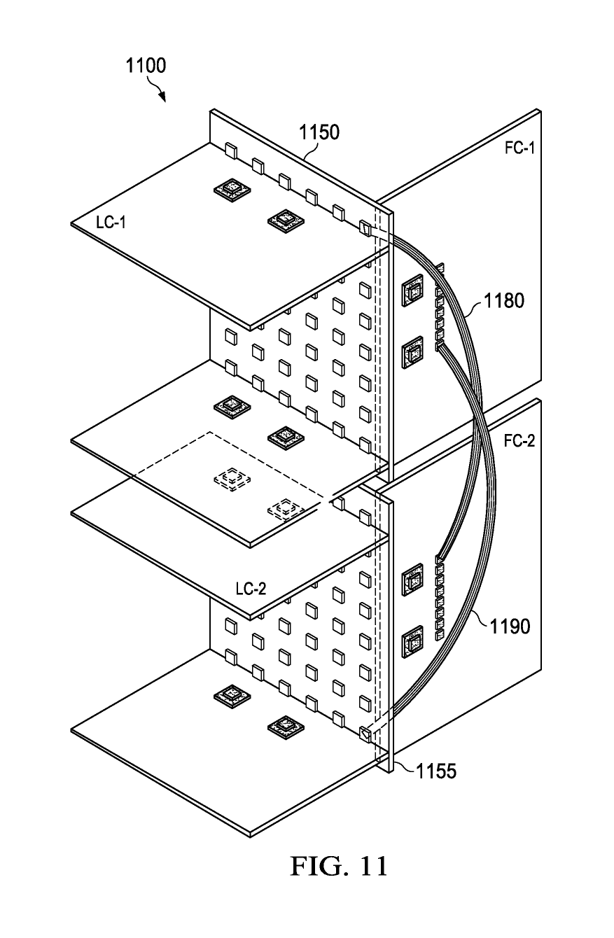

FIG. 11 illustrates another embodiment of a chassis configuration 1100 comprising horizontally configured LCs and vertically configured FCs engaged with a mid-plane 1150. As shown, a first set of high speed cables (e.g., the high speed cable 1180) interconnects a backside egress port of the mid-plane 1150 with a port of the FC-2, thereby allowing packets to be sent from upper LCs (e.g., the LC-1) to lower FC-2). Likewise, a second set of high speed cables (e.g., the high speed cable 1190) interconnects a back-side egress port of the mid-plane 1155 with a port of the FC-1, thereby allowing packets to be sent from lower LCs (e.g., the LC-2) to upper FC-1. The embodiments illustrated in FIGS. 9-11 are just a few examples of many possible configurations, and may be combined and/or altered to meet various design and/or practical objectives.

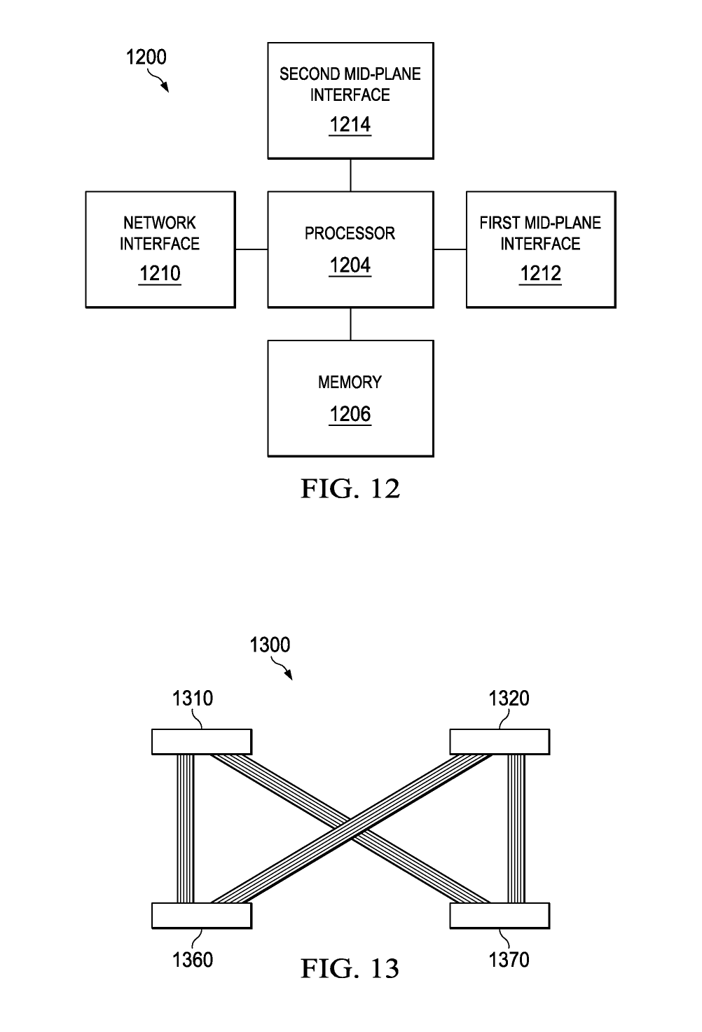

FIG. 12 illustrates a block diagram of an embodiment of a computing engine 1200, as may be found in a LC. The computing engine 1200 may include a processor 1204, a memory 1206, a network interface 1210, a first mid-plane interface 1212, and a second mid-plane interface 1214, which may be arranged as shown in FIG. 12, or otherwise. The processor 1204 may be any component capable of sorting packets and/or other processing related tasks, and the memory 1206 may be any component capable of storing programming and/or instructions for the processor 1204. The network interface 1210 may be any component or collection of components (e.g., ports) that allow the computing engine 1200 to receive/forward packets to/from a network, and may behave as an access point for one or more users. The first mid-plane interface 1212 and the second mid-plane interface 1214 may be any component or collection of components that allows the computing engine 1200 to communicate with a mid-plane. For instance, the first mid-plane interface 1212 may be a collection of ports over which the computing engine 1200 forwards packets bound for a proximately located LC and/or FC, while the second mid-plane interface 1214 may be a collection of ports over which the computing engine 1200 forwards packets bound for a remotely located LC and/or FC.

Advantages of the above described embodiments may allow an eight slot network switching center to be expanded to twelve or sixteen slots, thereby increasing the capacity of the network switching center by as much as fifty to one-hundred percent.

U.S. Patent Application Publication 2011/0038371 and U.S. Patent Application Publication 2011/0032934 may be relevant to the present disclosure, and are incorporated herein by reference as if reproduced in their entireties.

In some embodiments, an x-cable harness of soft connections may be used in lieu of hybrid connections. FIG. 13 illustrates an exemplary x-cable harness 1300, which is used to interconnect a pair of LCs 1310, 1320, to a pair of FCs 1360, 1370. The x-cable harness may reduce design constraints and/or manufacturing complexities. In some embodiments, the soft-cables may be ribbon cables.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed:

1. A line card comprising:
a first set of ports communicatively coupled to a first switching fabric via a hard connection, wherein the first switching fabric is capable of forwarding data to any one of a plurality of proximately located line cards without forwarding the data through any intermediate switching fabrics; and
a second set of ports communicatively coupled to a second switching fabric via a soft connection, wherein the second switching fabric is capable of forwarding data to any one of a plurality of remotely located line cards without forwarding the data through any intermediate switching fabrics.

2. The line card of claim 1, wherein the first set of ports are communicatively coupled to the first switching fabric without using any soft connections.

3. The line card of claim 1, wherein the soft connections comprises at least some low-loss conductive materials that do not meet rigidity requirements for printed circuit board (PCB) connections, and wherein the hard connections are PCB connections.

4. The line card of claim 1, wherein the first switching fabric is incapable of directly forwarding data to remotely located line cards, and wherein the second switching fabric is incapable of directly forwarding data to proximately located line cards without forwarding the data through one or more intermediate switching fabrics.

5. The line card of claim 1 further comprising:
a third set of ports for receiving a plurality of packets;
a processor; and
a computer readable storage medium storing programming for execution by the processor, the programming including instructions to:
receive the plurality of packets over the third set of ports;
sort the plurality of packets to distinguish a first set of the plurality of packets from a second set of the plurality of packets, the first set of packets being destined for one or more of the proximately located line cards and the second set of packets being destined for one or more of the remotely located line cards;
forwarding the first set of packets over the first set of ports; and
forwarding the second set of packets over the second set of ports.

6. The line card of claim 5, wherein the proximately plurality of packets are communicated using a high frequency signal.

7. The line card of claim 1, wherein the first switching fabric is part of a first fabric card that includes the hard connections, and wherein the second switching fabric is part of a second fabric card comprising an interface that is coupled to the soft connection.

8. The line card of claim 1, wherein the hard connections comprise printed circuit board (PCB) connections, and soft connections comprise high-speed cable.

9. The line card of claim 1, wherein the line card is coupled to the same mid-plane as each of the plurality of proximately located line cards, but a different mid-plane than each of the plurality of remotely located line cards.

10. A method for operating a first line card, the method comprising:
receiving a plurality of packets over an ingress interface of the first line card;
sorting the plurality of packets to distinguish a first set of the plurality of packets from a second set of the plurality of packets, the first set of packets being destined for a proximately located line card and the second set of packets being destined for a remotely located line card;
forwarding the first set of packets to a first switching fabric via a first hard connection, the first switching fabric and the first hard connection being components of a proximately located fabric card; and
forwarding the second set of packets to an interface associated with a second switching fabric via a soft connection, the second switching fabric a component of a remotely located fabric card.

11. The method of claim 10, wherein the interface associated with the second switching fabric is part of the remotely located fabric card.

12. The method of claim 10, wherein the first line card, the proximately located line card, and the proximately located fabric card are affixed to a first mid-plane, and
wherein the remotely located line card and the remotely located fabric card are affixed to a second mid-plane, the second mid-plane being separate and distinct from the first mid-plane.

13. The method of claim 12, wherein the interface associated with the second switching fabric is part of the second mid-plane, and
wherein packets received on the interface are forwarded to the second switching fabric via a second hard connection, the second hard connection being comprised with the remotely located fabric card.

14. The method of claim 10, wherein the first hard connection is a printed circuit board (PCB) connection.

15. The method of claim 10, wherein the soft connection is a high speed cable.

16. A hybrid chassis comprising:
a first fabric card comprising a first switching fabric;
a second fabric card comprising a second switching fabric;
a first set of line cards coupled to the first switching fabric via a first set of hard connections, and coupled to an interface associated with the second switching fabric via a soft connection; and
a second set of line cards coupled to the second fabric card.

17. The hybrid chassis of claim 16, wherein the first set of hard connections are printed circuit board (PCB) connections of the first fabric card, and
wherein the soft connection is a high speed cable.

18. The hybrid chassis of claim 16, wherein the interface associated with the second switching fabric is affixed to the second line card.

19. The hybrid chassis of claim 16 further comprising:
a first connection-plane coupled to the first set of line cards and the first fabric card; and
a second connection-plane coupled to the second set of line cards and the second fabric card, the second connection-plane being separate and distinct from the first connection-plane.

20. The hybrid chassis of claim 19, wherein the interface associated with the second switching fabric is affixed to the second connection-plane, and wherein packets received at the interface are forwarded to the second switching fabric via a second plurality of hard connections that are part of the second switching fabric.
